(19) United States
(12) Patent Application Publication
(10) Pub. No.: US 2009/0037876 A1
(43) Pub. Date: Feb. 5, 2009

(54) VISIBLE WHITE SPACE IN PROGRAM CODE

(75) Inventors: Henricus Johannes Maria Meijer, Mercer Island, WA (US); Avner Y. Aharoni, Seattle, WA (US); David N. Schach, Redmond, WA (US); Andrew E. Kimball, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/831,272

(22) Filed: Jul. 31, 2007

(51) Int. Cl. G06F 9/44

(52) U.S. Cl. 717/113

(57) ABSTRACT

White space is made visible in a code editor to facilitate identification thereof via color, symbols, characters and/or the like. Further, white space can be explicitly identified and distinctly presented of various types including significant, insignificant and editor introduced. White space information can also be employed to aid code compilation and/or processing.

### BACKGROUND

Computer programs are groups of instructions that describe actions to be performed by a computer or other processor-based device. When a computer program is loaded and executed on computer hardware, the computer will behave in a predetermined manner by following the instructions of the computer program. Accordingly, the computer becomes a specialized machine that performs the tasks prescribed by the instructions.

A programmer using one or more programming languages creates the instructions comprising a computer program. Typically, source code is specified or edited by a programmer manually and/or with help of an integrated development environment (IDE). Subsequently, the source code can be compiled or otherwise transformed by another program into computer instructions executable by a computer or like device.

By way of example, a programmer may choose to implement code utilizing an object-oriented programming language (e.g., Visual Basic, C#, Java . . . ). In accordance with such a paradigm, programmers create a number of classes identifying properties and characteristics of an abstract thing as well as methods describing class behavior or abilities. Specific programmatic logic can then be specified as interactions between instances of classes or objects, among other things. Subsequently, executable code for a particular machine can be produced by an associated compiler. Alternatively, code can be transformed into intermediate code for a target virtual machine to facilitate execution on multiple computer platforms via further compilation or interpretation of the intermediate code.

On a lower level, various characters are utilized to specify programs including letters and numbers. One particular member of a program language character set is white space. White space is an invisible or blank symbol corresponding to “ ” that is employed to provide horizontal and/or vertical space between a plurality of letters, numbers or other characters. Particular forms of white space include tabs, spaces and newlines. Among other things, programs can be specified with white spaces to format code with one or more tabs, spaces or the like to facilitate code comprehension and editing thereof.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Described briefly, the disclosed subject matter pertains to visible white space with respect to programmatic code. Rather than displaying white space in an invisible manner, at least some white space can be presented visibly. For example, conventional white spaces can be marked-up or replaced with one or more visible characters, symbols or a non-white color, among other things. Furthermore, white space can be visibly identifiable as significant or insignificant. In accordance with one aspect of the disclosure, a program editor is provided. The program editor can display code including visible white space and enable programmers to identify white space explicitly as significant or insignificant. According to another aspect, a processing system is disclosed that can compile or translate programming code in a manner that accounts for explicit identification of white space.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a code editor system in accordance with an aspect of the disclosed subject matter.

FIG. 2 is a block diagram of a code editor system including a space identifier in accordance with an aspect of the disclosed subject matter.

FIG. 3 is a block diagram of an exemplary code segment depicting white space types in accordance with an aspect of the disclosed subject matter.

FIG. 4a-c are exemplary code snippets to provide clarity and understanding with respect to aspects of the claimed subject matter.

FIG. 5 is an exemplary code segment corresponding to that of FIGS. 4b and c wherein white space is visible in accordance with an aspect of the claimed subject matter.

FIG. 6 is a block diagram of a code processing system in accordance with an aspect of the disclosed subject matter.

FIG. 7 is a flow chart diagram of a method of program presentation in accordance with an aspect of the disclosed subject matter.

FIG. 8 is a flow chart diagram of a method of displaying programs with various types of white space in accordance with an aspect of the disclosed subject matter.

FIG. 9 is a flow chart diagram of a method of program compilation in accordance with an aspect of the disclosed subject matter.

FIG. 10 is a flow chart diagram of a method of interacting with insignificant white space in accordance with an aspect of the disclosed subject matter.

FIG. 11 is a schematic block diagram illustrating a suitable operating environment for aspects of the subject disclosure.

FIG. 12 is a schematic block diagram of a sample-computing environment.

### DETAILED DESCRIPTION

Systems and methods are provided for visual presentation of white spaces in program code. White spaces are displayed by a program editor in manner that makes them more perceptible than blank regions. Furthermore, white spaces can be explicitly specified and distinguished visually based on their type, namely significant, insignificant and editor introduced. This provides developers with much more programming control. Further yet, explicitly identified white space can also be utilized alone or in conjunction with implicit information to process code, for example compiling code to an object model.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

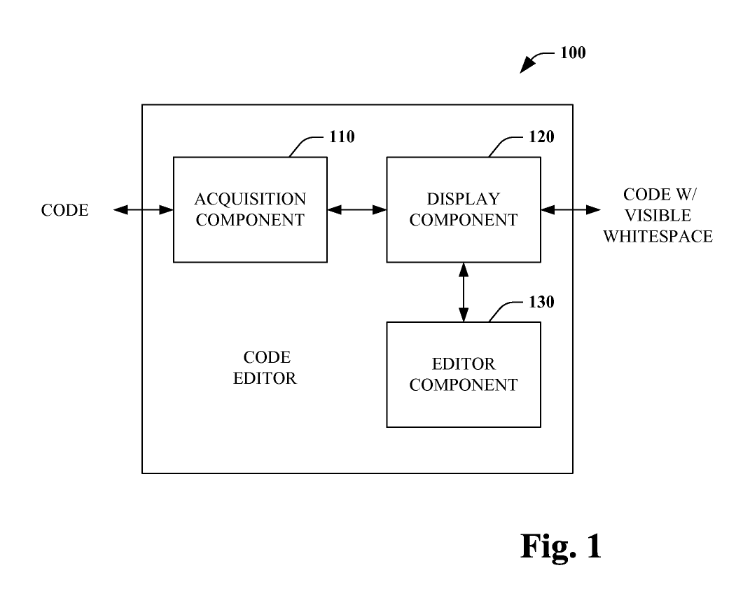

Referring initially to FIG. 1, a code editor system 100 is illustrated in accordance with an aspect of the claimed subject matter. The code editor system 100 can correspond to a source code editor designed to facilitate code editing and/or specification. Furthermore, the code editor system 100 can standalone or form part of an integrated development environment (IDE) providing further development tools including but not limited a compiler and/or interpreter, build-automation tools and a code debugger. The system 100 includes acquisition component 110, display component 120 and editor component 130.

The acquisition component 110 receives, retrieves or otherwise obtains or acquires program code. In accordance with one aspect but not limited thereto, the program code can correspond to source code or a sequence of statements, declarations and/or constructs, among other things, specified in a human-readable computer programming language (e.g., Visual Basic, C#, C++, Java, JavaScript, XQuery, HTML . . . ). Such code can be acquired from a local store or remotely over a network, for instance. Upon obtaining program code, the acquisition component can transmit or otherwise make the code available to the display component 120.

The display component 120 formats and outputs received or retrieved code for display on a computer screen, monitor or the like. In one instance, the display component 120 can inject space, align code or otherwise pretty print the code. In accordance with an aspect of the claimed subject matter, the display component 120 can also make spaces visible.

Spaces refer to characters that represent vertical or horizontal gaps in program code. Conventionally, space is not a visible mark but does occupy space. In the art as well as herein, such space is also referred to as white space since backgrounds are typically white. However, it is to be appreciated that space can be any other color that matches a background so as to cause it to be invisible (e.g. black, blue . . . ). Among other things, white space can correspond to a tab. space, new line and carriage return.

The display component 120 can make white spaces visible by injecting or substituting another character, symbol, or altering is color, inter alia. By way of example, the common text phase “Hello World” includes a space between “Hello” and “World.” The display component 120 could substitute a visual character to make the space perceptible such as a dot as in “Hello·World” or a cup symbol as in “Hello World.” Additionally or alternatively, the white space can be presented as non-white as in “Hello [symbol] World.” Furthermore, different forms of white space can be visualized dissimilarly. For instance, tabs can be represented by arrows such as “→” or “>>” while a new line can be denoted as “ [symbol] ” or the like.

The editor component 130 is a mechanism that allows software developers, among others, to specify or modify a displayed program, code or portion thereof Furthermore, the editor component 130 is extended to enable users to specify white space as a visible and/or invisible character. For example, a user can explicitly specify spaces to be visible and/or invisible. Additionally or alternatively, a developer can specify a portion of code or a scope over which white space is to be visible or invisible. Users can also employ the editor component 130 to identify exactly how they want spaces visualized via a color, character, symbol or the like. Where a symbol is utilized to represent white space and a programmer desires to also use the symbol in accordance with its normal meaning, an escape mechanism can be utilized such as quotes, for example “*”.

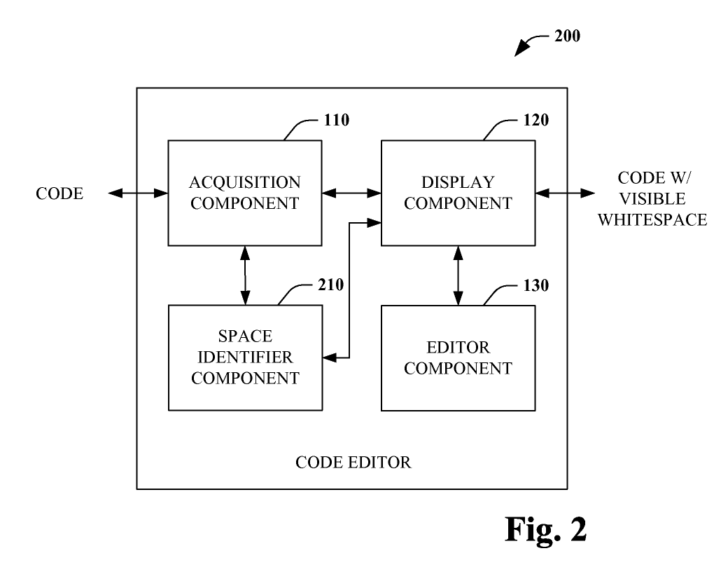

Turning attention to FIG. 2, a code editor system 200 is depicted in accordance with an aspect of the claimed subject matter. Similar to system 100 of FIG. 1, the system 200 includes the acquisition component 110, display component 120 and editor component 130, as previously described. In brief, the code is acquired by the acquisition component 110 and displayed with visible white space via display component 120. The code can be edited by a user utilizing the editor component 130. In particular, the editor component 130 can be employed to specify visible and/or invisible white space. The system 200 further includes a space identifier component 210. The space identifier component 210 determines and/or identifies different white space types associated with acquired code and provides the type to the display component 120 for display in a particular manner. The editor component 130 can also allow users to explicitly identify white space type as will be described further infra.

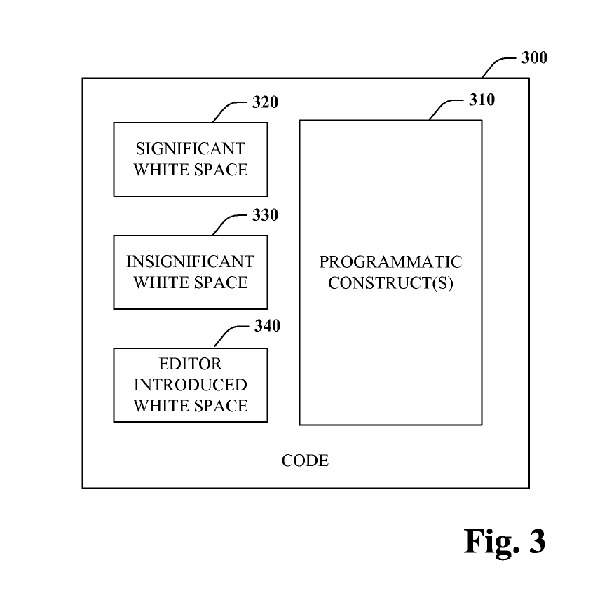

Not only can white space take different forms such as a tab, space, new line etc., but it can also be of different types. Referring briefly to FIG. 3, a block diagram of an exemplary code segment is depicted. As shown, the code segment 300 includes a plurality of programmatic constructs 310 utilized to construct a program control, flow, logic and the like. The code or program also includes three types of white space relative to one or more programmatic constructs 310, namely significant white space 320, insignificant white space 330 and editor introduced white space 340. Significant white space 320 is space that is part of a program's content that should be preserved. Insignificant white space 330 is not part of program content but is provided by a user to improve readability. Finally, editor introduced white space 330 is space introduced by an editor to format program code. This can be considered another type of insignificant white space. In another embodiment, for example, the insignificant white space 330 can have sub-categories for programmer and editor specified space.

In accordance with one aspect, a programmatic construct 310 can correspond to a code literal such as an XML code literal. In addition to markup language code literals, the programmatic construct 310 can also correspond to a multi-line string or string literal, for instance where balanced brackets or other symbols are utilized to delimit a multi-line string (e.g., “ [symbol] . . . multi-line string . . . [symbol] ”). A code literal is notation for representing a value in a programming language.

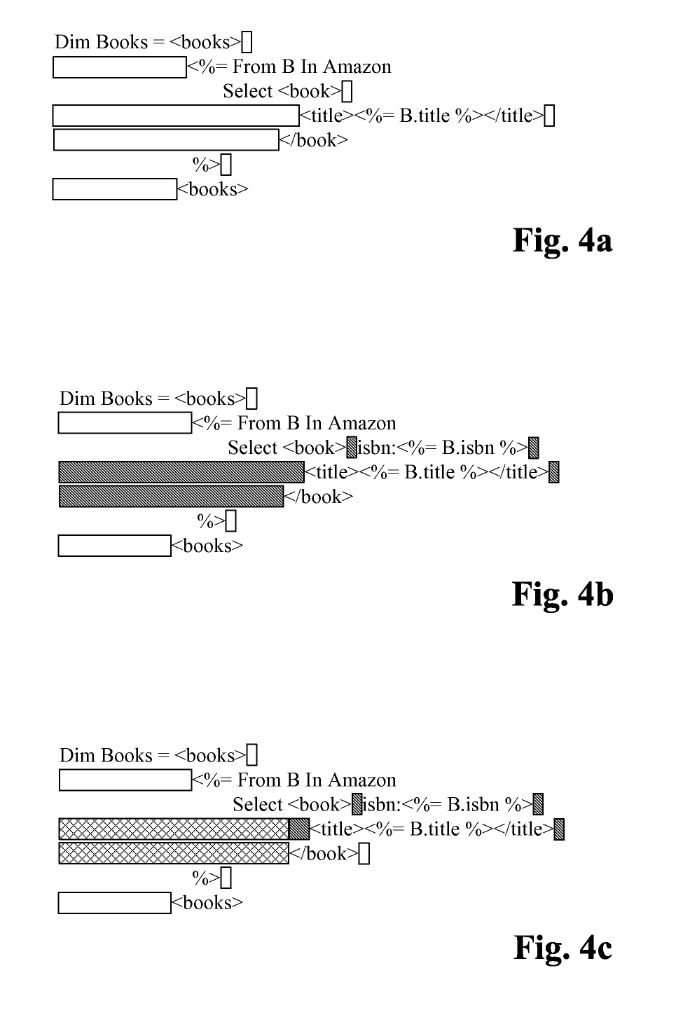

Turning attention to FIGS. 4a-c, exemplary code snippets of an XML code literal and assignment are provided to illustrate an identified issue with conventional invisible white space. These examples are solely to provide clarity and understanding with respect to aspects of claimed subject and not meant to limit the same.

Referring to FIG. 4a, sample code is provided that iterates through all books in an “Amazon” collection, selects their titles and assigns the titles to the field/variable “Books.” To facilitate clarity, invisible specified white space is shown utilizing white rectangles. All other white space corresponds to editor introduce white space. Here, all specified white space is insignificant and provided solely to format or pretty list the code.

XML literals work very well for XML data, but less well for generating mixed content and documents that contain significant white space. FIG. 4b illustrates an example where an ISBN number is inserted inside the “<book>” element as mixed content. Utilizing a rule such as all white space in text nodes is insignificant except when a text node includes at least one non-white space character, all white space represented by black rectangles now becomes significant due to the addition of the mixed content. However, when printing the subject document and stripping insignificant white space, it will look distorted because there is too much significant whitespace. In fact, only a portion of the data is really significant. Referring to FIG. 4c, the hatched rectangle identifies white space accidentally identified as significant when it is really insignificant.

The problem is that since white space is invisible it is impossible to identify which white space areas are significant and which are insignificant. As a result, code literals such the one above can produce accidental, unexpected and/or distorted results. This is a problem in general, but it is also confusing because there is no feedback to a user considering white space type. Conventionally, the only way to identify which space is significant and which is not is to run the program and look at the output. Even then, it is confusing to experts, so for normal users this is extremely problematic. A solution is to make at least one type of white space visible. Furthermore, users can be enabled to change significant white space into insignificant white space or vice versa.

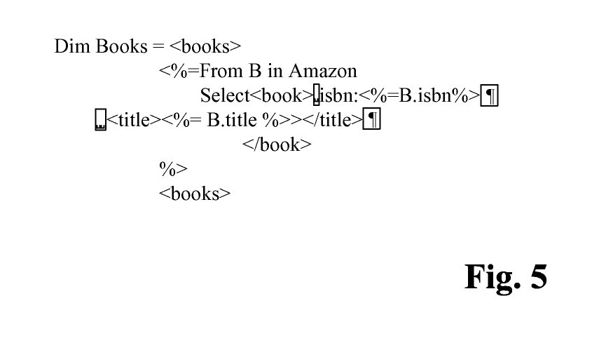

Referring briefly to FIG. 5, exemplary code corresponding to that of FIGS. 4b and c is provided wherein white space is visible in accordance with an aspect of the claimed subject matter. As shown, cup and paragraph symbols (“ ” and “ [symbol] ” are utilized to identify visually significant white space in the form of space and new lines specifically. Additionally or alternatively, white space can be changed to a non-white or non-background color to visualized white space. Here in FIG. 5, the rectangles surrounding the cup and paragraph symbols are meant to denote a non-white color in the black and white figure. The color can be indicative of significant white space and/or the particular forms thereof. For example, green can be utilized it identify significant white space and various shades of green employed with respect to tabs, spaces, new lines and the like. Using this mechanism, programmers have absolute control over white space in their literals and other programmatic constructs. In this example, only the visible white space will be part of the resulting literal. Accordingly, the actual placement of the fragment on the line does not matter.

A number of variations are available with respect to visualizing and/or explicitly designating visual white space all of which are to been deemed within the scope of the appended claims. By way of example and not limitation, consider editor-introduced white space. In one embodiment, since the editor in some sense owns such white space it can made un-editable by programmers. Alternatively, since the space is solely provided to pretty print of format data, the space can be edited or modified by users, for instance insignificant space can be designated as significant.

Furthermore, attributes, metadata or the like can be employed or ignored with respect to visualizing white space. For example, attributes associated with XML nodes indicating whether or not white space should be preserved such as “xml:space=default|preserve” can be used or ignored with respect to making white space visible. In the case of “xml:space,” this is a processing instruction for applications trying to load an XML document indicating whether white-space should be stripped or preserved. Since it is a processing instruction, during document creation or specification the instruction can be ignored. Alternatively, the instruction can be utilized to facilitate identification of significant and/or insignificant white space and visual presentation thereof Accordingly, this can be a program or editor option that can be toggled.

In another instance, it should be appreciated that white space visualization information can be captured typographically. In scenarios in which a conventional editor is utilized to view or edit a file that does not support more complex white space visualization mechanisms, the code can still be specified in an appropriate manner. For example, a sequence of one or more stars such as “*” can be utilized to identify significant white space. Where the same code is opened utilizing visualization enabled browser, the stars can be interpreted as stars or alternatively transformed to colors and/or alternate symbols or markings. Again, where standard typographical characters, symbols or the like are utilized to visualize white space an escape mechanism such as quotes can be utilized to indicate that a program intends to designate the primary meaning of the character rather than a white space meaning.

Given the general concept of making significant white space significant, there are a number of other issues that can be resolved by the editor system 200 of FIG. 2 in various manners. For example, where can significant white space occur? One embodiment can support occurrence of white space only at positions where spaces might be stripped such as right after and before element tags, whereas another embodiment can support the occurrence of white space anywhere. The question is whether inside text nodes such as “<span>Hello World</span>” significant white space can be introduced and/or marked as such. There are costs and benefits associated with each implementation. In particular, marking all significant white space as such is consistent. Alternatively, allowing insignificant white space inside text nodes makes them easier to layout over multiple lines.

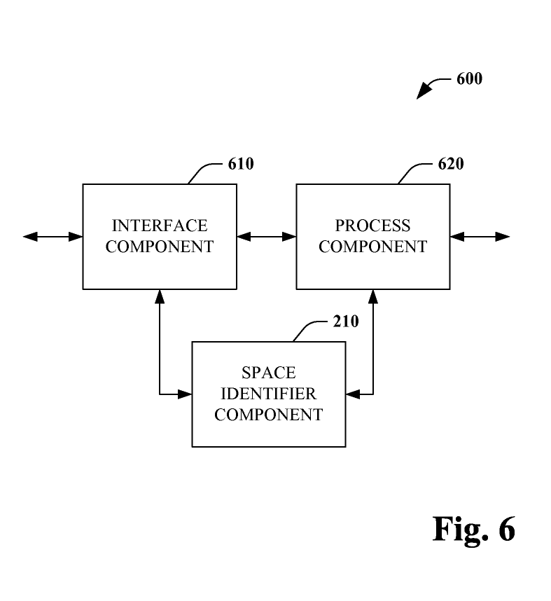

Referring to FIG. 6, a code processing system 600 is illustrated in accordance with an aspect of the claimed subject matter. In one embodiment the code system 600 can correspond to compilation system. However, other embodiments are also possible and within the scope of invention. The system 600 includes space interface component 610, process component 620 and space identifier 210.

In accordance with the compiler embodiment, the interface component 610 can receive, retrieve or otherwise acquire program code and make the code available to the process component 620. The process component 620 can compile or transform the code from one format to another. Unlike conventional compilers, the system 600 can consider explicitly designated white space in the compilation process.

In particular, the space identification component 210 can be employed to identify white space types such as significant, insignificant and/or editor introduced to the process component 610. The process component 610 can then compile code as a function of this information. In one instance, this information can be utilized to compile code into an associated object model. For example, the process component 610 can take code literals such as XML literals and compile them into method calls or constructor calls that create instances of an object model that represents that piece of code. Now, the processor component 610 can also take into account the fact that some space is significant and some is not and reflect that in an underlying object model.

In one scenario, the process component 610 can interpret significant white space as a special literal. More particularly, a literal can correspond to a sequence of significant spaces. For example “ [symbol] ” can be an abbreviation for an expression hole or embedded expression “<%=” “&” “&” “&” “&” “%>” that includes five space characters. Similarly, all other significant white space tokens can be translated into embedded expressions containing the correct normal strings.

In effect, by enabling programmatic control over white space via visualization and explicit specification of significant and/or insignificant white space, among other things, generated programs are much more predictable than conventional programs. As a result, developers will not be surprised by results or require a trial an error approach to affording appropriate white space. In one instance, code literals can be can be utilized to generated desired object model instances that can subsequently be processed to produce expected results.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. For example, the space identifier component 210 can be embedded within either or both or the display component 220 and process component 620. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems and methods can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

By way of example and not limitation, the space identifier component 210 can utilize such mechanisms to infer significant and/or insignificant white space as a function of contextual information such as explicit specification and/or processing attributes among other things. Furthermore, similar mechanisms can be employed by the space identifier component 210 to provide hints, suggestions or recommendations to a user regarding explicit white space specification. For example, the space identifier component 210 can interact with a code editor or integrated development environment's intelligent assistance component (not shown) to provide such information.

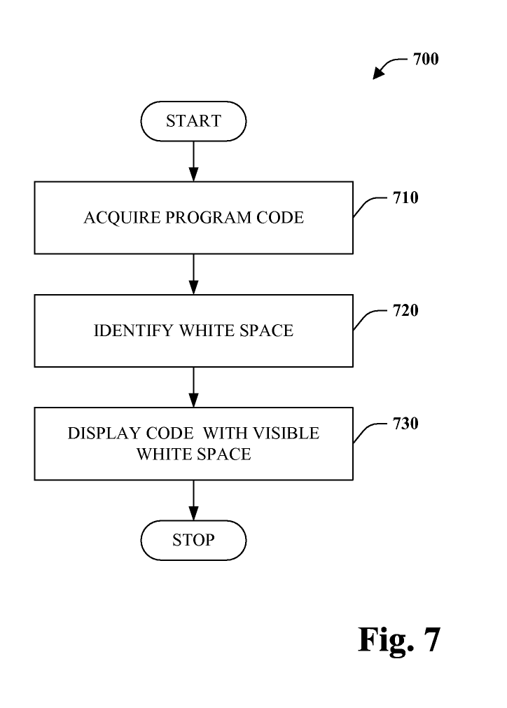

In view of the exemplary systems described supra, methodologies that may be implemented in accordance with the disclosed subject matter will be better appreciated with reference to the flow charts of FIGS. 7-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 7, a method of program presentation 700 is depicted in accordance with an aspect of the claimed subject matter. At reference numeral 710, a program code is acquired. Among other things, program code can correspond to source code written in one or more of a plurality of languages including but not limited to Visual Basic, C#, XQuery (XML Query language) and XSLT (eXtensible Stylesheet Language Transformation). White spaces are in the program code identified at reference numeral 720. At numeral 730, the program code is displayed with white space rendered visible. In one instance, conventional invisible white space can be replaced with a visible character, symbol or the like. The characters can be distinct to further denote differing white space forms including tabs, spaces, new lines and the like. Additionally or alternatively, white space can be transformed to a non-white color to facilitate identification.

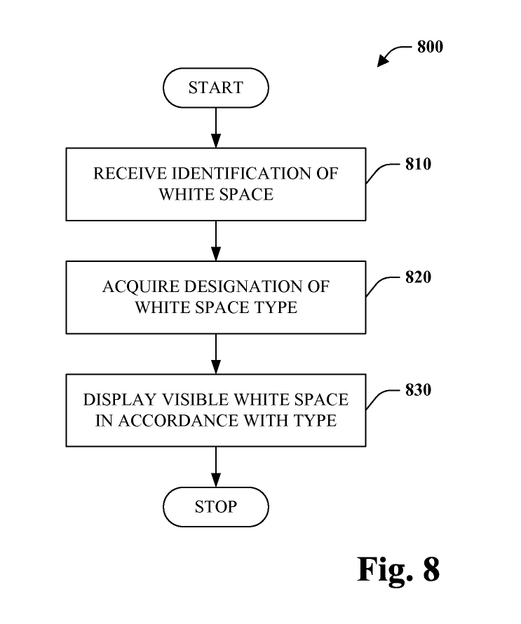

FIG. 8 is a flow chart diagram of a method of program display in accordance with an aspect of the claimed subject matter. At reference numeral 810, identification of a white space is received, for instance from a user. At numeral 820, a type is acquired for the identified white space. The type can be either significant or insignificant. Significant whitespace is part of code content that is to be preserved. Insignificant white space is not part of the code and can be provided for formatting or pretty printing. This type information can also be acquired from user input. At reference numeral 830, white space is displayed in a visible manner in accordance with an identified type. For example, distinct characters or colors can be utilized to make otherwise invisible white space visible and easily identified as either significant or insignificant.

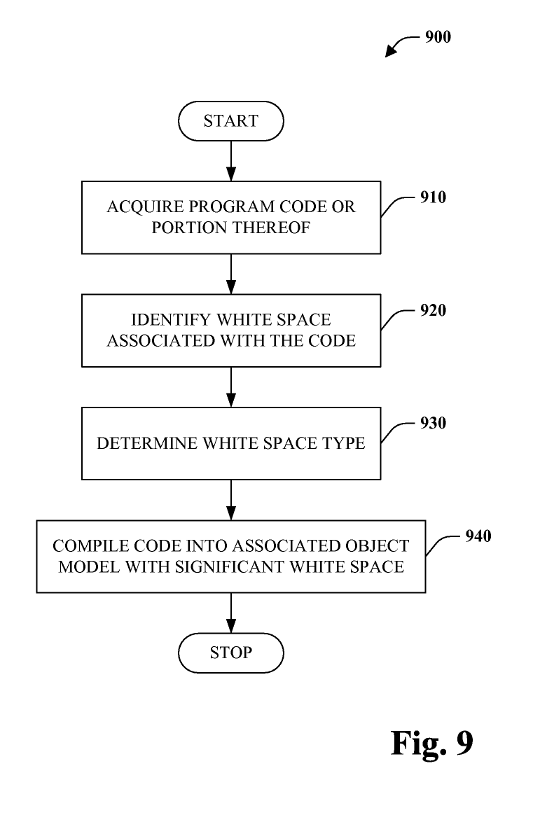

FIG. 9 illustrates a method of code compilation 900 in accordance with an aspect of the claimed subject matter. At reference numeral 910, program code or a portion thereof is acquired. Code white space is identified at numeral 920. At reference 930, the type of the white space is determined, for example significant and/or insignificant. This determination can be based on explicit and/or implicit specification thereof. For example, in a system that requires all significant white space to be explicitly specified in some visual manner, then white space identified in such a manner can be deemed significant while all other white space deemed insignificant. At numeral 940, the code is compiled into an associated object model utilizing significant and/or insignificant white space. For example, an XML literal can be utilized to construct an instance of a XML data model.

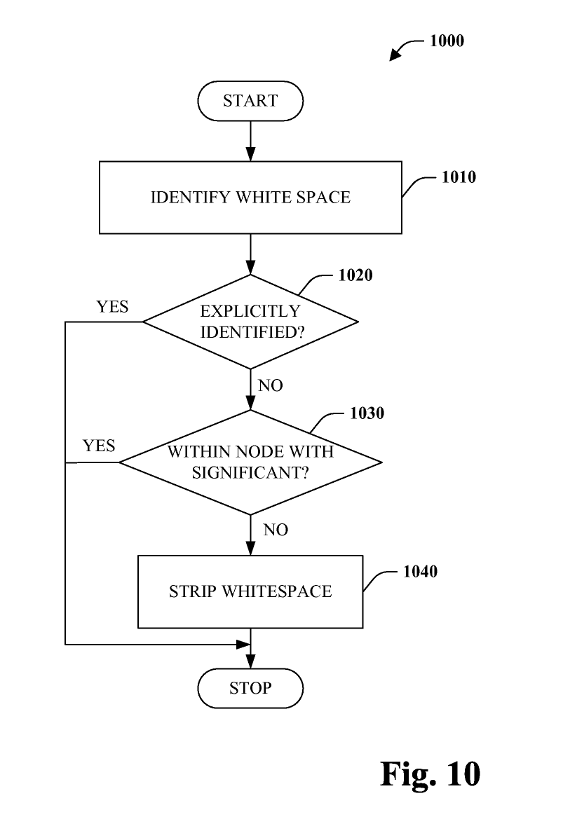

FIG. 10 is a flow chart diagram illustrating a method 1000 of interacting with insignificant white space. At reference numeral 1010, white space from program code is identified. As previously mentioned, white space can be any vertical or horizontal space including but not limited to tabs, spaces and new lines. At reference 1020, a determination is made as to whether the identified white space is explicitly identified for example via one or more visible characters or symbols and or non-white space (e.g., red, green, blue . . . ). Furthermore, the determination can be made as a function of an attribute metadata or the like associated with the white space (e.g., “xml:space”). If the white space is explicitly specified as insignificant, the method can proceed to 1040 where the white space is stripped. Alternatively, if the white space is not explicitly identified it can be implicitly insignificant. Accordingly, the method 1000 continues at 1030 where a check is made as to whether the white space is within a node or other like container. If it is not, then the white space can be deeded insignificant and stripped or removed at reference numeral 740. Alternatively, if the white space is within a node such as the space between “Hello” and “World” in “Hello World,” then the method 1000 can simply terminate.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

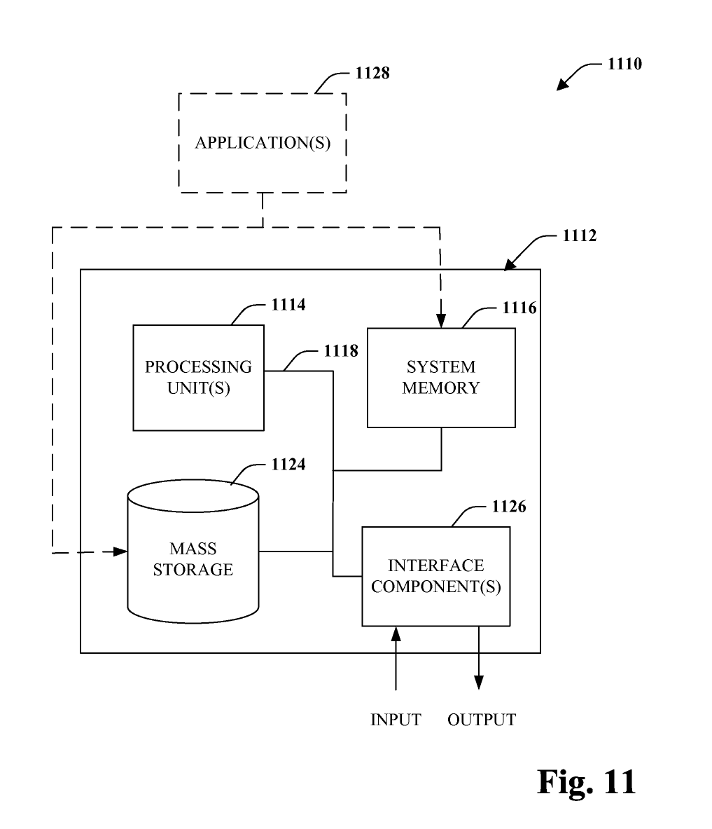

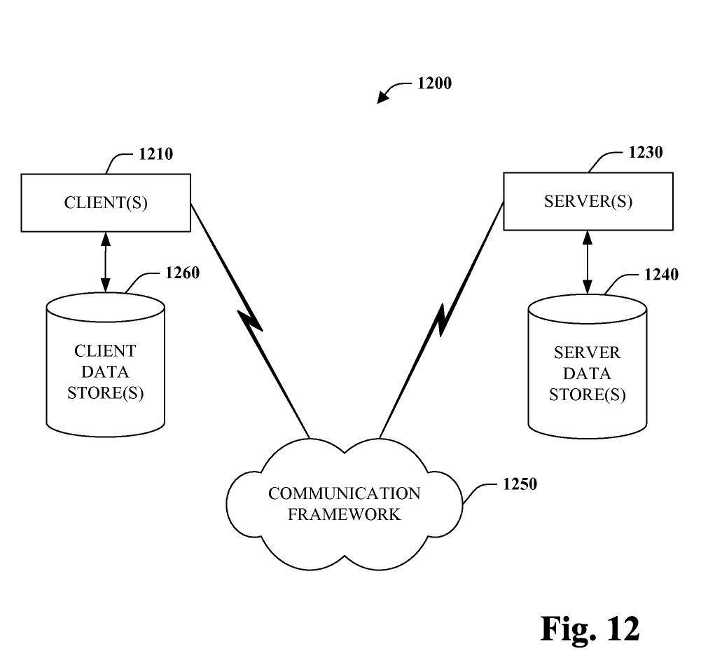

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 11, an exemplary environment 1110 for implementing various aspects disclosed herein includes a computer 1112 (e.g., desktop, laptop, server, hand held, programmable consumer or industrial electronics . . . ). The computer 1112 includes a processing unit 1114, a system memory 1116 and a system bus 1118. The system bus 1118 couples system components including, but not limited to, the system memory 1116 to the processing unit 1114. The processing unit 1114 can be any of various available microprocessors. It is to be appreciated that dual microprocessors, multi-core and other multiprocessor architectures can be employed as the processing unit 1114.

The system memory 1116 includes volatile and nonvolatile memory. The basic input/output system (BIOS), containing the basic routines to transfer information between elements within the computer 1112, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1112 also includes removable/non-removable, volatile/non-volatile computer storage media. FIG. 11 illustrates, for example, mass storage 1124. Mass storage 1124 includes, but is not limited to, devices like a magnetic or optical disk drive, floppy disk drive, flash memory or memory stick. In addition, mass storage 1124 can include storage media separately or in combination with other storage media.

FIG. 11 provides software application(s) 1 128 that act as an intermediary between users and/or other computers and the basic computer resources described in suitable operating environment 1110. Such software application(s) 1128 include one or both of system and application software. System software can include an operating system, which can be stored on mass storage 1124, that acts to control and allocate resources of the computer system 1112. Application software takes advantage of the management of resources by system software through program modules and data stored on either or both of system memory 1116 and mass storage 1124.

The computer 1112 also includes one or more interface components 1126 that are communicatively coupled to the bus 1118 and facilitate interaction with the computer 1112. By way of example, the interface component 1126 can be a port (e.g., serial, parallel, PCMCIA, USB, FireWire . . . ) or an interface card (e.g., sound, video, network . . . ) or the like. The interface component 1126 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1112 to output device(s) via interface component 1126. Output devices can include displays (e.g. CRT, LCD, plasma . . . ), speakers, printers and other computers, among other things.

FIG. 12 is a schematic block diagram of a sample-computing environment 1200 with which the subject innovation can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing the aspects of the subject innovation, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

For example, a client 1210 can retrieve source code from a server 1230 over communication framework 1250 or alternative from client data store 1260. Subsequently, a user can explicitly specify visual white space associated with the code can compile the code in a manner as described above. Compiler generated code can then be run on the client 1210 or alternatively transferred back over the communication framework 1240 to the server 1230 for execution thereon and/or transmission to other clients 120. Furthermore, a program editor system 100 or 120 in accordance with the claimed subject matter can be resident as a service provided by the one or more servers 1230 for access and use by one or more clients 1210. Still further yet, functionality associated with display of visual white space and/or explicit identification of thereof can be house in a data packet and downloaded from a server 1230 for installation on a client 1210. In this manner, conventional program editors and/or integrated development environments can be extended with this functionality.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A program editor system, comprising:
an acquisition component that acquires source program code; and
a display component that displays the code with visible white space.

2. The system of claim 1, the display component displays white space in a non-white color.

3. The system of claim 1, the display component replaces white space with symbols and/or characters.

4. The system of claim 1, further comprising an identifier component that distinguishes significant white space from insignificant white space.

5. The system of claim 4, the display component displays white space in different manners to visually distinguish significant and insignificant white space.

6. The system of claim 5, significant white space is visible and insignificant whitespace is invisible or significant white space is invisible and insignificant whitespace is visible.

7. The system of claim 5, significant white space and insignificant whitespace are displayed in different colors.

8. The system of claim 5, the identifier component identifies editor introduced white space and the display component displays the editor introduced white space distinct from significant and insignificant white space.

9. The system of claim 1, further comprising an editor component that enables explicit user specification of visible white space.

10. The system of claim 9, the editor facilitates specification of significant and/or insignificant whitespace in a distinct visible manner.

11. The system of claim 1, the source code includes a code literal and white space within and/or surrounding the code literal.

12. A method of program compilation, comprising:
acquiring programmatic code; and
compiling significant and/or insignificant white space into an object model associated with the code.

13. The method of claim 12, further comprising stripping insignificant white space from the code.

14. The method of claim 12, acquiring programmatic code comprising acquiring a markup language or a multi-line string literal.

15. The method of claim 14, further comprising interpreting significant white space as a special literal specifying a sequence of spaces.

16. The method of claim 12, further comprising identifying the significant and/or insignificant white space as a function of explicit declaration thereof.

17. The method of claim 16, further comprising identifying the white space as a function of an attribute associated with a particular programmatic construct and/or group of constructs.

18. The method of claim 16, further comprising ignoring an attribute associated with one or more programmatic constructs that indicates that white space is to be preserved.

19. A computer readable medium having stored thereon a computer program, comprising:
a programmatic construct; and
explicitly identified significant and/or insignificant whitespace associated with the construct.

20. The computer readable medium of claim 19, the programmatic construct is a markup language or multi-line string literal.
